(19) United States
(12) Patent Application Publication
(10) Pub. No.: US 2009/0224611 A1
(43) Pub. Date: Sep. 10, 2009

(54) DOCKING STATION AND ULTRASONIC DIAGNOSTIC APPARATUS

(76) Inventor: You Chen, Wuxi (CN)

Correspondence Address: Patrick W. Rasche;Armstrong Teasdale LLP, Suite 2600, One Metropolitan Square, St. Louis, MO, 63102, US

(21) Appl. No.: 12/396,684

(22) Filed: Mar. 3, 2009

(30) Foreign Application Priority Data
Mar. 7, 2008 (CN) 200810083499.1

(51) Int. Cl. H01H 35/00

(52) U.S. Cl. 307/126

(57) ABSTRACT

A docking station to which a portable electronic device is detachably mounted and to which a peripheral device is connected, includes a section for turning on or off the power supply of the peripheral device according to the attachment/detachment state of the electronic device to the docking station and according to the on-state or the off-state of the power supply of the electronic device.

### CROSS REFERENCE TO RELATED APPLICATIONS

This application claims the benefit of Chinese Patent Application No. 200810083499.1 filed Mar. 7, 2008, which is hereby incorporated by reference in its entirety.

### BACKGROUND OF THE INVENTION

The embodiments described herein relate to a docking station and an ultrasonic diagnostic apparatus, and more particularly to a docking station to which a portable electronic device is detachably mounted and to which a peripheral device is connected, and an ultrasonic diagnostic apparatus provided with the docking station.

Since a function of a portable electronic device is limited, such portable electronic device is used as docked with an extension station when the function needs extension. The extension station has an extended function, and is configured such that a portable electronic device is detachably mounted thereto. Therefore, the extension station is integrated with a portable electronic device for providing a function equal to that of a fixed electronic device. The extension station is also referred to as a docking station (e.g., see paragraphs [0004] and [0005] and FIG. 1 of Japanese Unexamined Patent Publication No. 2000-89855).

A portable ultrasonic diagnostic apparatus is one type of portable electronic devices. When the function of the portable ultrasonic diagnostic apparatus is extended, it is mounted to a dedicated docking station for use. The docking station is provided with a probe driving system, a data processing system, a memory system, a power supply system, a peripheral device connection system, etc., the functions thereof being extended, and the portable ultrasonic diagnostic apparatus can be operated equal to a fixed ultrasonic diagnostic apparatus by the operations of these systems (e.g., see paragraphs [0049] and [0050], and FIGS. 3 and 5 of Japanese Unexamined Patent Publication No. 2002-200079).

Various peripheral devices are connected to an ultrasonic diagnostic apparatus. Appropriate general-purpose apparatuses, such as large-capacity storage device (e.g., HD (hard disk)), image recording device (e.g., DVD (digital versatile disk) or VCR (video cassette recorder)), printing device (e.g., monochrome printer or color printer), etc., are used as the peripheral devices (e.g., see paragraph [0016] and FIG. 1 of Japanese Unexamined Patent Publication No. 2001-37755).

When plural peripheral devices are connected to the docking station, the power supply should be turned on or off each time the peripheral devices are started to be used or stopped. The operation of the power supply described above should be performed independently of the on/off of the power supply of the portable electronic device on the docking station, so that the operation becomes complicated.

Therefore, when the power supply of the portable electronic device on the docking station is turned on or when the portable electronic device is removed from the docking station, the power supply of the peripheral device frequently remains ON. In this case, the state in which power is uselessly consumed is continued forever.

### BRIEF DESCRIPTION OF THE INVENTION

It is desirable that the problems described previously are solved.

According to one aspect, a docking station to which a portable electronic device is detachably mounted and to which a peripheral device is connected, includes a section for turning on or off the power supply of the peripheral device according to the attachment/detachment state of the electronic device to the docking station and according to the on-state or the off-state of the power supply of the electronic device.

In a second aspect, and according to the first aspect, the section for turning on or off the power supply of the peripheral device includes: an operation section that performs a logical operation to a binary signal indicating the attachment/detachment state of the electronic device and a binary signal indicating the on-state or the off-state of the power supply of the electronic device; and an on/off section for turning on or off the electric power supply to the peripheral device on the basis of the result of the logical operation.

In a third aspect, and according to the second aspect, the binary signal indicating the attachment/detachment state of the electronic device respectively becomes true or false according to the establishment or non-establishment of both of the attachment of the electronic device and the on-state of the power supply, and the binary signal indicating the on-state or the off-state of the power supply of the electronic device respectively becomes true or false according to the on-state or off-state of the power supply of the electronic device.

In a fourth aspect, and according to the second aspect, the binary signal indicating the attachment/detachment state of the electronic device respectively becomes true or false according to the attachment or detachment of the electronic device, and the binary signal indicating the on-state or off-state of the power supply of the electronic device respectively becomes true or false according to the on-state or off-state of the power supply of the electronic device.

In a fifth aspect, and according to either the third aspect or fourth aspect, the logical operation is an AND operation.

In a sixth aspect, and according to the second aspect, the binary signal indicating the attachment/detachment state of the electronic device and the binary signal indicating the on-state or off-state of the power supply of the electronic device are transmitted to the docking station from the electronic device through a docking port.

In a seventh aspect, and according to the sixth aspect, the docking port has a flat connector.

In an eighth aspect, and according to the seventh aspect, the connector has two transmitting sections that respectively transmit the binary signal indicating the attachment/detachment state of the electronic device and the binary signal indicating the on-state or off-state of the power supply of the electronic device.

In a ninth aspect, and according to the eighth aspect, the two transmitting sections are apart from each other at the connector.

In a tenth aspect, and according to the ninth aspect, the two transmitting sections are positioned at both ends of the connector.

According to an eleventh aspect, an ultrasonic diagnostic apparatus includes a portable ultrasonic diagnostic device; a docking station to which the portable ultrasonic diagnostic device is detachably mounted; and a peripheral device connected to the docking station, wherein the docking station includes a section for turning on or off the power supply of the peripheral device according to the attachment/detachment state of the ultrasonic diagnostic device to the docking station and according to the on-state or the off-state of the power supply of the ultrasonic diagnostic device.

In a twelfth aspect, and according to the eleventh aspect, the section for turning on or off the power supply of the peripheral device includes: an operation section that performs a logical operation to a binary signal indicating the attachment/detachment state of the ultrasonic diagnostic device and a binary signal indicating the on-state or the off-state of the power supply of the ultrasonic diagnostic device; and an on/off section for turning on or off the electric power supply to the peripheral device on the basis of the result of the logical operation.

In a thirteenth aspect, and according to the twelfth aspect, the binary signal indicating the attachment/detachment state of the ultrasonic diagnostic device respectively becomes true or false according to the establishment or non-establishment of both of the attachment of the ultrasonic diagnostic device and the on-state of the power supply, and the binary signal indicating the on-state or the off-state of the power supply of the ultrasonic diagnostic device respectively becomes true or false according to the on-state or off-state of the power supply of the ultrasonic diagnostic device.

In a fourteenth aspect, and according to the twelfth aspect, the binary signal indicating the attachment/detachment state of the ultrasonic diagnostic device respectively becomes true or false according to the attachment or detachment of the ultrasonic diagnostic device, and the binary signal indicating the on-state or off-state of the power supply of the ultrasonic diagnostic device respectively becomes true or false according to the on-state or off-state of the power supply of the electronic device.

In a fifteenth aspect, and according to either the thirteenth aspect or the fourteenth aspect, the logical operation is an AND operation.

In a sixteenth aspect, and according to the twelfth aspect, the binary signal indicating the attachment/detachment state of the ultrasonic diagnostic device and the binary signal indicating the on-state or off-state of the power supply of the ultrasonic diagnostic device are transmitted to the docking station from the ultrasonic diagnostic device through a docking port.

In a seventeenth aspect, and according to the sixteenth aspect, the docking port has a flat connector.

In an eighteenth aspect, and according to the seventeenth aspect, the connector has two transmitting sections that respectively transmit the binary signal indicating the attachment/detachment state of the ultrasonic diagnostic device and the binary signal indicating the on-state or off-state of the power supply of the ultrasonic diagnostic device.

In a nineteenth aspect, and according to the eighteenth aspect, the two transmitting sections are apart from each other at the connector.

In a twentieth aspect, and according to the nineteenth aspect, the two transmitting sections are positioned at both ends of the connector.

According to the first aspect, the docking station to which a portable electronic device is detachably mounted and to which a peripheral device is connected, includes a section for turning on or off the power supply of the peripheral device according to the attachment/detachment state of the electronic device to the docking station and according to the on-state or the off-state of the power supply of the electronic device. Therefore, the docking station has excellent operability of a power supply of a peripheral device.

According to the eleventh aspect, the ultrasonic diagnostic apparatus has a portable ultrasonic diagnostic device, a docking station to which the portable ultrasonic diagnostic device is detachably mounted, and a peripheral device connected to the docking station, wherein the docking station includes a section for turning on or off the power supply of the peripheral device according to the attachment/detachment state of the ultrasonic diagnostic device to the docking station and according to the on-state or the off-state of the power supply of the ultrasonic diagnostic device. Therefore, the ultrasonic diagnostic apparatus is provided with a docking station having excellent operability of a power supply of a peripheral device.

According to the second and twelfth aspects of the invention, the section for turning on or off the power supply of the peripheral device includes an operation section that performs a logical operation to a binary signal indicating the attachment/detachment state of the ultrasonic diagnostic device and a binary signal indicating the on-state or the off-state of the power supply of the ultrasonic diagnostic device, and an on/off section for turning on or off the electric power supply to the peripheral device on the basis of the result of the logical operation. Therefore, the power supply of the peripheral device can appropriately be turned on or off according to the attachment/detachment state of the electronic device to the docking station and the on-state or off-state of the power supply of the electronic device.

According to the third and thirteenth aspects of the invention, the binary signal indicating the attachment/detachment state of the ultrasonic diagnostic device respectively becomes true or false according to the establishment or non-establishment of both of the attachment of the ultrasonic diagnostic device and the on-state of the power supply, and the binary signal indicating the on-state or the off-state of the power supply of the ultrasonic diagnostic device respectively becomes true or false according to the on-state or off-state of the power supply of the ultrasonic diagnostic device. Therefore, the attachment/detachment state of the electronic device to the docking station with the power supply turned on and the on/off state of the power supply of the electronic device can appropriately be shown.

According to the fourth and fourteenth aspects of the invention, the binary signal indicating the attachment/detachment state of the ultrasonic diagnostic device respectively becomes true or false according to the attachment or detachment of the ultrasonic diagnostic device, and the binary signal indicating the on-state or off-state of the power supply of the ultrasonic diagnostic device respectively becomes true or false according to the on-state or off-state of the power supply of the ultrasonic diagnostic device. Therefore, the attachment/detachment state of the electronic device to the docking station and the on/off state of the power supply of the electronic device can appropriately be shown.

According to the fifth and fifteenth aspects of the invention, the logical operation is an AND operation. Therefore, the on/off section can appropriately be driven according to the attachment/detachment state of the electronic device to the docking station and the on/off state of the power supply of the electronic device.

According to the sixth and sixteenth aspects of the invention, the binary signal indicating the attachment/detachment state of the ultrasonic diagnostic device and the binary signal indicating the on-state or off-state of the power supply of the ultrasonic diagnostic device are transmitted to the docking station from the ultrasonic diagnostic device through a docking port. Therefore, the signal can be transmitted with the attachment and detachment of the electronic device to the docking station.

According to the seventh and seventeenth aspects of the invention, the docking port has a flat connector. Therefore, the attachment and detachment of the electronic device to the docking station and the signal transmission with the attachment and the detachment can appropriately be performed.

According to the eighth and eighteenth aspects of the invention, the connector has two transmitting sections that respectively transmit the binary signal indicating the attachment/detachment state of the ultrasonic diagnostic device and the binary signal indicating the on-state or off-state of the power supply of the ultrasonic diagnostic device. Therefore, the signals of two types can appropriately be transmitted.

According to the ninth and nineteenth aspects of the invention, the two transmitting sections are apart from each other at the connector. Therefore, the signal transmission can be performed only in the state in which the electronic device is completely attached.

According to the tenth and twentieth aspects of the invention, the two transmitting sections are positioned at both ends of the connector. Therefore, the signal transmission can be performed only in the state in which the electronic device is completely attached.

Further objects and advantages of the embodiments described herein will be apparent from the following description as illustrated in the accompanying drawings.

### BRIEF DESCRIPTION OF THE DRAWINGS

FIG. 1 is a view showing an exemplary configuration of an ultrasonic diagnostic apparatus.

FIG. 2 is a top view of the ultrasonic diagnostic apparatus shown in FIG. 1.

FIG. 3 is a view showing a configuration of a top board that may be used with the ultrasonic diagnostic apparatus shown in FIGS. 1 and 2.

FIG. 4 is a block diagram showing an electrical structure of the ultrasonic diagnostic apparatus shown in FIGS. 1 and 2.

### DETAILED DESCRIPTION OF THE INVENTION

Embodiments of the invention will be explained in detail with reference to the drawings. The invention is not limited to embodiments described herein.

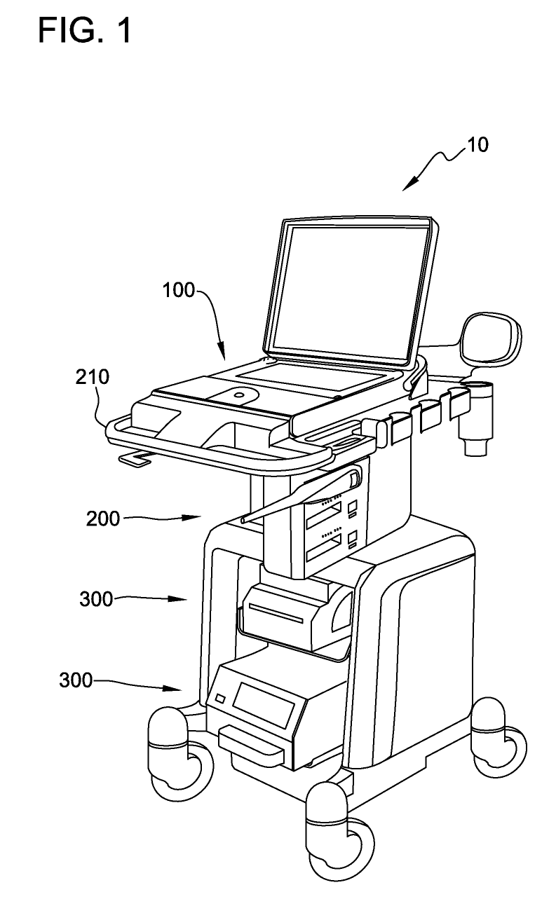

FIG. 1 is an external view showing the configuration of an exemplary ultrasonic diagnostic apparatus 10. The configuration of the ultrasonic diagnostic apparatus 10 represents one example of an ultrasonic diagnostic apparatus. Further, a part of the configuration of the ultrasonic diagnostic apparatus 10 represents one example of a docking station.

As shown in FIG. 1, the ultrasonic diagnostic apparatus 10 is composed of three types of electronic devices 100, 200 and 300, which are connected to one another. The electronic device 100 is a portable ultrasonic diagnostic device. The portable ultrasonic diagnostic device has an appearance similar to a notebook-type PC (personal computer).

The electronic device 100 is also referred to as an ultrasonic diagnostic device 100.

The electronic device 200 is a docking station. The docking station has various electronics systems for extending the function of the portable ultrasonic diagnostic device, such as a probe driving system, data processing system, memory system, power supply system, peripheral device connection system, etc., the functions of which are reinforced. The docking station has wheels for traveling so as to function as a cart. The electronic device 200 is also referred to as a docking station 200 below.

The electronic device 300 is a peripheral device. Usable peripheral device includes a large-capacity storage device such as HD, image recording device such as DVD or VCR, printing device such as monochrome printer or color printer, or other suitable general-purpose devices. The electronic device 300 is also referred to as a peripheral device 300 below.

The electronic device 100 is not limited to an ultrasonic diagnostic device. Any other suitable electronic devices may be employed as the electronic device 100. The electronic device 200 and the electronic device 300 are not limited to the docking station and peripheral device for the ultrasonic diagnostic device. A docking station and peripheral device for extending the function of the above-mentioned other electronic devices may be employed. The wheels for traveling are not necessarily indispensable.

The ultrasonic diagnostic device 100 is mounted on a horizontal top board 210 at the upper part of the docking station 200. With this state, both are mechanically coupled by a connecting/releasing mechanism, and are electrically connected with a connector.

The peripheral device 300 is housed in a tray at the lower part of the docking station 200. The peripheral device 300 is connected to the docking station 200 through a signal cable, and commercial AC power is supplied through the docking station 200.

The ultrasonic diagnostic device 100 constitutes a fully-equipped ultrasonic diagnostic system with the docking station 200. The ultrasonic diagnostic device 100 can be removed from the docking station 200, and used singly for performing a basic ultrasonic diagnosis. In this case, the ultrasonic diagnostic device 100 is operated by power from a self-contained battery.

The attachment of the ultrasonic diagnostic device 100 to the docking station 200 is referred simply as the attachment (mounting) of the ultrasonic diagnostic device 100, and the removal of the ultrasonic diagnostic device 100 from the docking station 200 is simply referred to as a removal (detachment) of the ultrasonic diagnostic device 100.

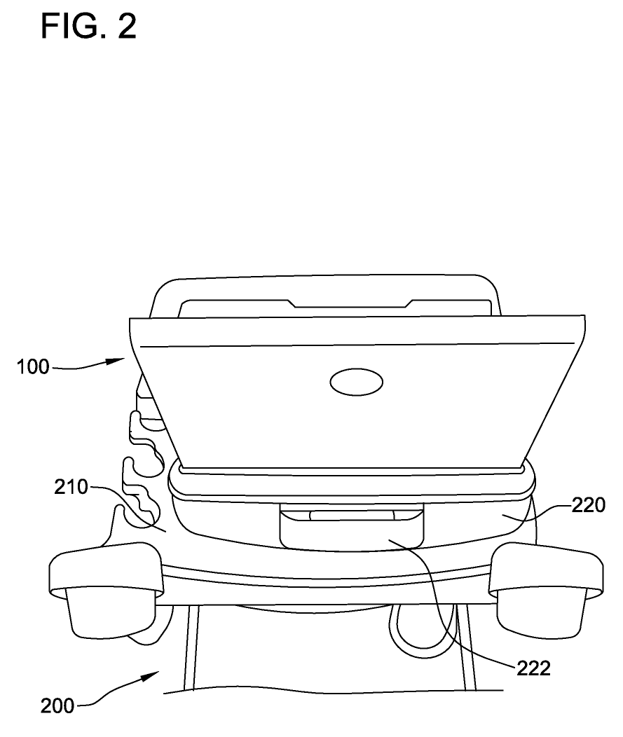

FIG. 2 shows the connection state of the ultrasonic diagnostic device 100 and the docking station 200 seen from the backside. As shown in FIG. 2, the rear face of the ultrasonic diagnostic device 100 comes in contact with a bank 220 of the top board 210 from the front side. With this state, the ultrasonic diagnostic device 100 and the docking station 200 are mechanically and electrically connected to each other.

A handle 222 that can be pressedly inserted is mounted to the bank 220. The mechanical and electrical connection between the ultrasonic diagnostic device 100 and the docking station 200 can be released by pushing the handle 222 in the forward direction.

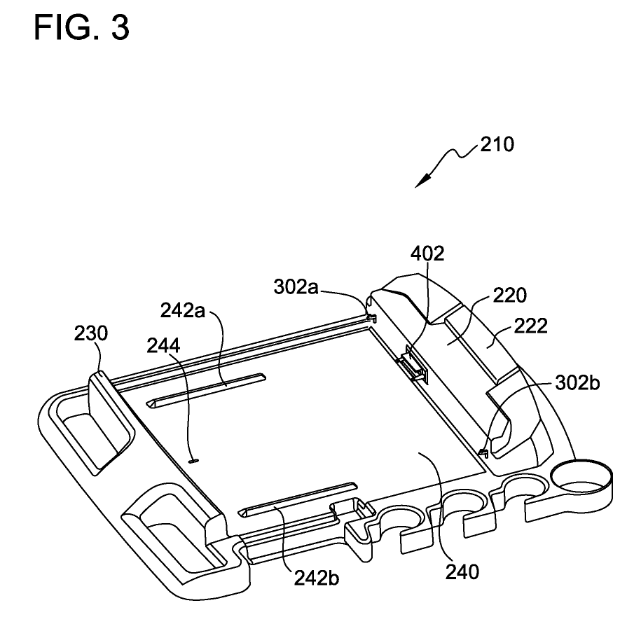

FIG. 3 shows the configuration of the top board 210. As shown in FIG. 3, the top board 210 has two banks 220 and 230. The banks 220 and 230 are respectively the front bank and the rear bank. A flat board 240 is disposed between the rear bank 220 and the front bank 230. The ultrasonic diagnostic device 100 is mounted on the flat board 240.

A pair of hooks 302a and 302b and a connector plug 402 are projected forward from the front wall of the rear bank 220. These hooks 302a and 302b and the connector plug 402 correspond to a pair of hook receivers and a connector receptacle provided at the rear surface of the ultrasonic diagnostic device 100. The connector plug 402 constitutes a flat connector with the connector receptacle.

A pair of rails 242a and 242b and a hook 244 are provided on the flat board 240. The direction of the rails 240a and 240b is perpendicular to the bank 220. The rails 242a and 242b and the hook 244 respectively correspond to a pair of sliders and a hook receiver provided at the bottom surface of the ultrasonic diagnostic device 100.

When the ultrasonic diagnostic device 100 is placed on the flat board 240 in such a manner that the rear surface thereof opposes to the front surface of the bank 220, and pressed to the bank 220 with the rails 242a and 242b as guides, the hooks 302a, 302b, and 244 and the connector plug 402 are engaged with the corresponding three hook receivers and the connector receptacle of the ultrasonic diagnostic device 100. Thus, the mechanical and electrical connection of the ultrasonic diagnostic device 100 and the docking station 200 is established.

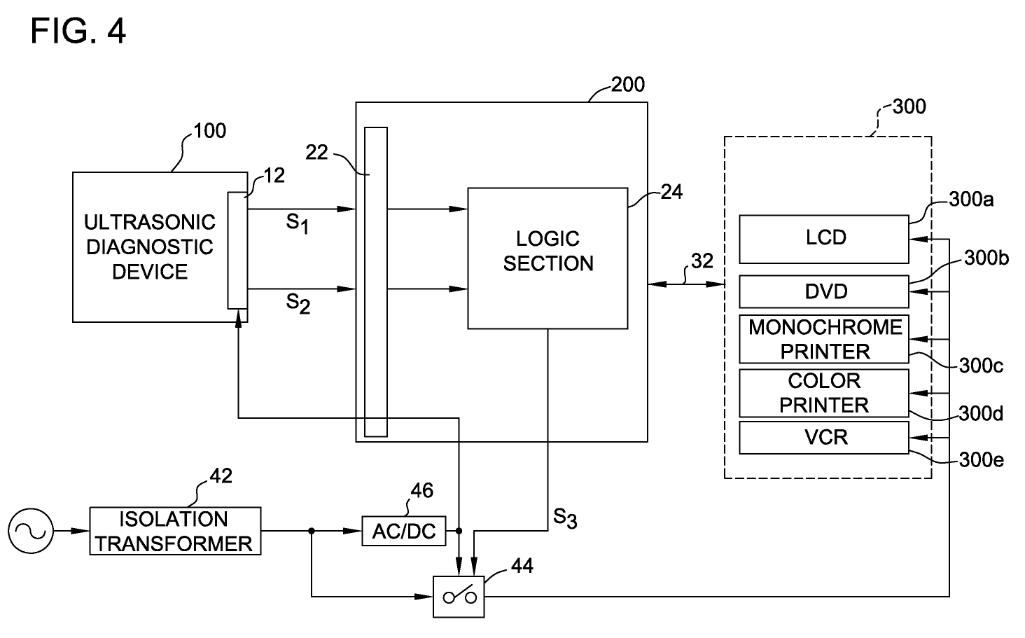

FIG. 4 is a block diagram showing an electrical structure of the ultrasonic diagnostic apparatus 10. Attention is paid on the portions relating to the operation of the peripheral device, and the other portions are simplified in the illustration. As shown in FIG. 4, the ultrasonic diagnostic device 100 has a docking port 12, and the docking station 200 has a docking port 22. The ultrasonic diagnostic device 100 and the docking station 200 are connected through the docking ports 12 and 22.

The docking port 12 includes the connector receptacle provided at the rear surface of the ultrasonic diagnostic device 100. The docking port 22 includes the connector plug 402 provided to the rear bank 220 of the top board 210. The connector receptacle and the connector plug are generically named a connector below.

The peripheral device 300 is connected to the docking station 200 via a signal cable 32. Usable peripheral devices 300 include an LCD (liquid crystal display) 300a, DVD 300b, monochrome printer 300c, color printer 300d, and VCR 300e. An USB (universal serial bus) cable or VGA (video gate array) cable is used as the signal cable 32.

Commercial AC power is supplied, as a power supply, to the peripheral device 300 through an isolation transformer 42 and a power supply on/off circuit 44. The AC output power of the isolation transformer 42 is converted into DC power at an AD/DC circuit 46 to be supplied to the ultrasonic diagnostic device 100, the docking station 200 and the power supply on/off circuit 44 as a power supply.

Two types of signals S1 and S2 are transmitted from the ultrasonic diagnostic device 100 to the docking station 200 through the docking ports 12 and 22. The signal S1 is a binary signal indicating the attachment/detachment state of the ultrasonic diagnostic device 100 to the docking station 200, while the signal S2 is a binary signal indicating the on/off state of the power supply of the ultrasonic diagnostic device 100. The signal S1 is referred to as a working signal, while the signal S2 is referred to as a power status signal below.

The logical value of the working signal S1 becomes true when the ultrasonic diagnostic device 100 is attached with the power supply turned on. The logical value thereof becomes false in the other cases, such as when the ultrasonic diagnostic device 100 is attached with the power supply turned off, when the ultrasonic diagnostic device 100 is removed with the power supply turned on, and when the ultrasonic diagnostic device 100 is removed with the power supply turned off.

The logical value of the power status signal S2 becomes true and false according to the on-state and off-state of the power supply of the ultrasonic diagnostic device 100. Considering that the on/off state of the power supply of the ultrasonic diagnostic device 100 is reflected on the power status signal S2, the logical value of the working signal S1 may instead become true and false respectively according to the attachment and detachment of the ultrasonic diagnostic device 100.

The working signal S1 and the power status signal S2 are respectively transmitted through two transmitting sections of the connector. The two transmitting sections are apart from each other at the connector. Preferably, the two transmitting sections are located at both ends of the connector. Thus, the working signal S1 and the power status signal S2 are transmitted only when the ultrasonic diagnostic device 100 is properly mounted to the docking station 200.

The docking station 200 performs a logical operation for the working signal S1 and the power status signal S2 by a logic section 24, and inputs the result to the power supply on/off circuit 44 as a control signal S3.

The logical operation at the logic section 24 is an AND operation. Accordingly, the logical value of the control signal S3 becomes true when both of the working signal S1 and the power status signal S2 are true, and false when one or both of the working signal S1 and the power status signal S2 are false. The power supply on/off circuit 44 feeds the commercial AC power to the peripheral device 300 when the logical value of the control signal S3 is true, while cuts off the electric power supply of the commercial AC power when the logical value of the control signal S3 is false.

The logic section 24 and the power supply on/off circuit 44 are one example of the section for turning on or off the power supply of the peripheral device in the invention. The logic section 24 is one example of an operation section in the invention. The power supply on/off circuit 44 is one example of an on/off section in the invention.

Thanks to the operations of the logic section 24 and the power supply on/off circuit 44, power supply is fed to the peripheral device 300 only when the working signal S1 and the power status signal S2 are both true. When one or both of the working signal S1 and the power status signal S2 are false, the power supply is not fed.

When the ultrasonic diagnostic apparatus 100 is properly mounted to the docking station 200 and the power supply thereof is turned on, both of the working signal S1 and the power status signal S2 become true. Only during this state, the power supply is fed to the peripheral device 300. Conversely, when one or both of the proper attachment of the ultrasonic diagnostic device 100 and the on-state of the power supply are not established, the power supply is not fed to the peripheral device 300.

The power supply of the peripheral device 300 can be turned on or off with the attachment/detachment of the ultrasonic diagnostic device 100 to the docking station 200 and the on/off of the power supply of the ultrasonic diagnostic device 100. Therefore, it is unnecessary to turn on or off the power supplies of the respective peripheral devices 300a, 300b, 300c, 300d, and 300e one by one.

Specifically, in order to turn the power supply of the peripheral device 300 on, the ultrasonic diagnostic device 100 may be attached to the docking station 200 with the power supply turned on or the power supply of the ultrasonic diagnostic device 100 is turned on after it is attached to the docking station 200.

In order to turn the power supply of the peripheral device 300 off, the power supply of the ultrasonic diagnostic device 100 may be turned off with the ultrasonic diagnostic device 100 attached to the docking station 200 or the ultrasonic diagnostic device 100 may be removed from the docking station 200 with the power supply turned on.

Many widely different embodiments of the invention may be configured without departing from the spirit and the scope of the present invention. It should be understood that the present invention is not limited to the specific embodiments described in the specification, except as defined in the appended claims.

1. A docking station to which a portable electronic device is detachably mounted and to which a peripheral device is connected, said docking station comprising:
a section configured to turn on and turn off a power supply of the peripheral device according to an attachment/detachment state of the electronic device to said docking station and according to an on-state or an off-state of the power supply of the electronic device.

2. A docking station according to claim 1, wherein:
said section configured to turn on and turn off a power supply of the peripheral device comprises:
an operation section configured to perform a logical operation to a binary signal indicating the attachment/detachment state of the electronic device and a binary signal indicating the on-state or the off-state of the power supply of the electronic device; and
an on/off section configured to turn on and turn off the power supply to the peripheral device based on a result of the logical operation.

3. A docking station according to claim 2, wherein:
the binary signal indicating the attachment/detachment state of the electronic device respectively becomes true or false according to an establishment or non-establishment of both of the attachment of the electronic device and the on-state of the power supply; and
the binary signal indicating the on-state or the off-state of the power supply of the electronic device respectively becomes true or false according to the on-state or off-state of the power supply of the electronic device.

4. A docking station according to claim 2, wherein:
the binary signal indicating the attachment/detachment state of the electronic device respectively becomes true or false according to an attachment or detachment of the electronic device; and
the binary signal indicating the on-state or off-state of the power supply of the electronic device respectively becomes true or false according to the on-state or off-state of the power supply of the electronic device.

5. A docking station according to claim 3, wherein:
the logical operation is an AND operation.

6. A docking station according to claim 2, wherein:
the binary signal indicating the attachment/detachment state of the electronic device and the binary signal indicating the on-state or off-state of the power supply of the electronic device are transmitted to said docking station from the electronic device through a docking port.

7. A docking station according to claim 6, wherein:
said docking port comprises a flat connector.

8. A docking station according to claim 7, wherein:
said connector comprises two transmitting sections configured to respectively transmit the binary signal indicating the attachment/detachment state of the electronic device and the binary signal indicating the on-state or off-state of the power supply of the electronic device.

9. A docking station according to claim 8, wherein:
said transmitting sections are spaced apart from each other at said connector.

10. A docking station according to claim 9, wherein:
said transmitting sections are positioned at both ends of said connector.

11. An ultrasonic diagnostic apparatus comprising:
a portable ultrasonic diagnostic device;
a docking station to which said portable ultrasonic diagnostic device is detachably mounted; and
a peripheral device connected to said docking station, said docking station comprising:
a section configured to turn on and turn off a power supply of said peripheral device according to an attachment/detachment state of said ultrasonic diagnostic device to said docking station and according to an on-state or an off-state of said power supply of said ultrasonic diagnostic device.

12. An ultrasonic diagnostic apparatus according to claim 11, wherein:
said section configured to turn on and turn off said power supply of said peripheral device comprises:
an operation section configured to perform a logical operation to a binary signal indicating the attachment/detachment state of said ultrasonic diagnostic device and a binary signal indicating the on-state or the off-state of said power supply of said ultrasonic diagnostic device; and
an on/off section configured to turn on and turn off the power supply to said peripheral device based on a result of the logical operation.

13. An ultrasonic diagnostic apparatus according to claim 12, wherein:
the binary signal indicating the attachment/detachment state of said ultrasonic diagnostic device respectively becomes true or false according to an establishment or non-establishment of both of the attachment of said ultrasonic diagnostic device and the on-state of said power supply; and
the binary signal indicating the on-state or the off-state of said power supply of said ultrasonic diagnostic device respectively becomes true or false according to the on-state or off-state of said power supply of said ultrasonic diagnostic device.

14. An ultrasonic diagnostic apparatus according to claim 12, wherein:
the binary signal indicating the attachment/detachment state of said ultrasonic diagnostic device respectively becomes true or false according to the attachment or detachment of said ultrasonic diagnostic device; and
the binary signal indicating the on-state or off-state of said power supply of said ultrasonic diagnostic device respectively becomes true or false according to the on-state or off-state of said power supply of said ultrasonic diagnostic device.

15. An ultrasonic diagnostic apparatus according to claim 13, wherein:
the logical operation is an AND operation.

16. An ultrasonic diagnostic apparatus according to claim 12, wherein:
the binary signal indicating the attachment/detachment state of said ultrasonic diagnostic device and the binary signal indicating the on-state or off-state of said power supply of said ultrasonic diagnostic device are transmitted to said docking station from said ultrasonic diagnostic device through a docking port.

17. An ultrasonic diagnostic apparatus according to claim 16, wherein:
said docking port comprises a flat connector.

18. An ultrasonic diagnostic apparatus according to claim 17, wherein:
said connector comprises two transmitting sections configured to respectively transmit the binary signal indicating the attachment/detachment state of said ultrasonic diagnostic device and the binary signal indicating the on-state or off-state of said power supply of said ultrasonic diagnostic device.

19. An ultrasonic diagnostic apparatus according to claim 18, wherein:
said transmitting sections are spaced apart from each other at said connector.

20. An ultrasonic diagnostic apparatus according to claim 19, wherein:
said transmitting sections are positioned at both ends of said connector.
